(19) United States
(12) Patent Application Publication
(10) Pub. No.: US 2017/0287610 A1
(43) Pub. Date: Oct. 5, 2017

(54) MAGNETIC AUTO-REPEL SHOCK HELMET

(71) Applicant: Hollis Matthew Tapp, Cedar Park, TX (US)

(72) Inventor: Hollis Matthew Tapp, Cedar Park, TX (US)

(21) Appl. No.: 15/475,809

(22) Filed: Mar. 31, 2017

Related U.S. Application Data
(60) Provisional application No. 62/317,236, filed on Apr. 1, 2016.

(51) Int. Cl. H01F 7/06; A42B 3/30; A42B 3/06; A42B 3/04; A63B 71/10

(52) U.S. Cl. CPC H01F 7/064; A42B 3/046; A63B 71/10; A42B 3/063; A42B 3/30

(57) ABSTRACT

Comprehensive systems of providing shock resistant protection for sports activities and other activities that utilize helmets or other specialized apparel, and related methods. The system functions by employing electromagnetic devices that provide a dampening, anti-impact electromagnetic field to reduce potential impacts.

### CROSS-REFERENCE TO RELATED APPLICATION

This application claims the benefit of the filing document of U.S. Provisional Patent Application 62/317,236, filed Apr. 1, 2016, which is hereby incorporated by reference.

### TECHNICAL FIELD

The present disclosure is directed, in general, to helmets for sports, driving, and other functions, and other apparel, that offer increased safety to their wearers.

### BACKGROUND OF THE DISCLOSURE

Many sports and other activities have risk of injury by impact, whether intentional or not. Techniques for avoiding or reducing injury are desirable.

### SUMMARY OF THE DISCLOSURE

Various disclosed embodiments include helmets and other apparel that reduce the risk of impact injury by using magnetic fields to reduce or avoid such impacts.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWING

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a helmet in which an embodiment can be implemented; and

FIG. 2 illustrates a flowchart of a process in accordance with disclosed embodiments.

### DETAILED DESCRIPTION

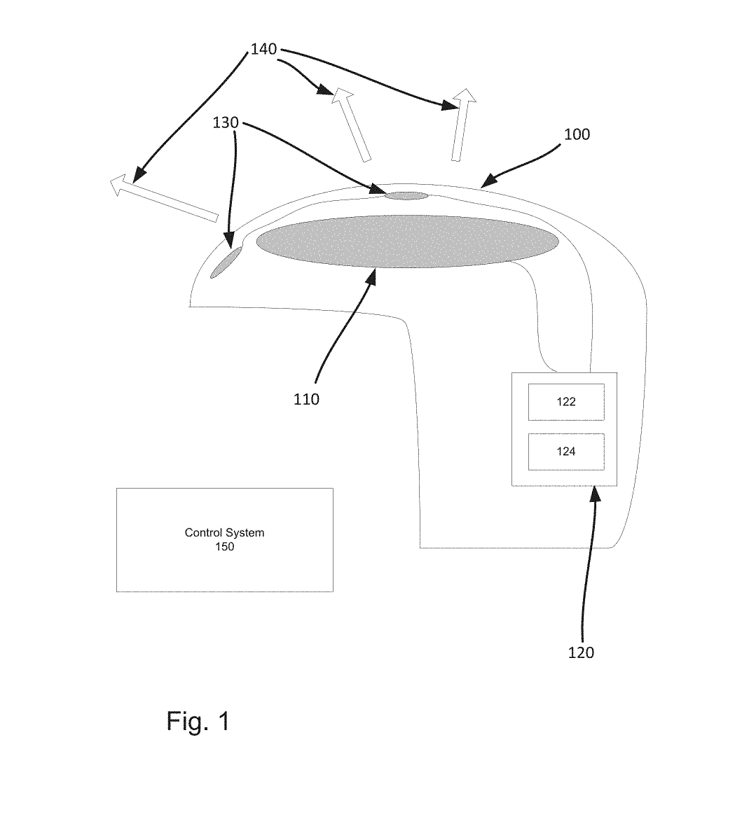

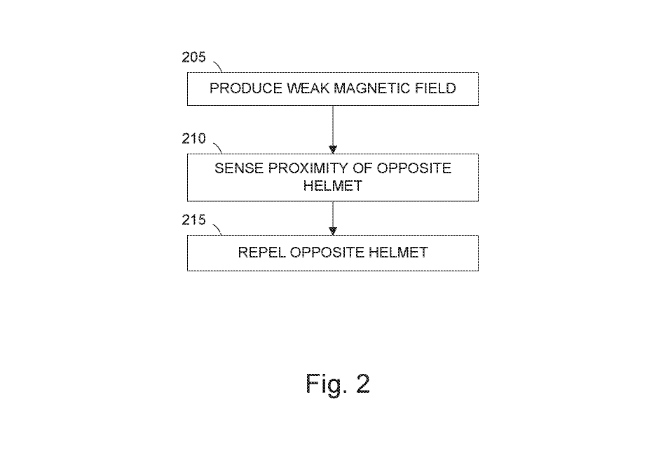

FIGS. 1 and 2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include a comprehensive system of providing shock resistant protection for sports activities and other activities that utilize helmets or other specialized apparel. According to some embodiments, the system functions by employing electromagnetic devices mounted in the helmet upper frontal area that provide a dampening, anti-impact field when coming in very close proximity to the opposing team's like charged device. “Apparel” is intended to refer to any article of clothing, gear, protective material or object, or other object worn or mounted on a human body.

According to disclosed embodiments, power for the electromagnetic device is provided by a small battery pack that could be mounted in the helmet, shoulder pads, or other locations within the protective padding of the typical protective pad compliment, or on or within other apparel worn by the user.

In the simplest application, the magnet devices remain charged and interact only when in close proximity to the opposing team's protective compliment. In various embodiments, if field strength, battery life, thermal issues, or other practical limitations arise, the devices can remain inert, being activated by similarly mounted proximity sensors as imminent impact is detected. The strength of the engaged device (field) would be adjustable. This allows a range of protection; from the minor softening of impact, as might be desirable in professional sports—to significant repulsion of impact, as beneficial in the sporting activity of children. The most radical field-strength available would be reasonably less than the field required to create an opposite whiplash effect. If required, directional focus can be controlled by shielding and other methods that prevent extraneous unwanted interactions and effects.

FIG. 1 illustrates an example of a helmet 100 in accordance with disclosed embodiments. Such a helmet can be, for example, a sporting helmet such as for football, automobile racing, or other sports, or can be a helmet for other safety purposes, such as construction or otherwise. While this example illustrates a helmet, the techniques disclosed herein apply to other apparel and protective gear, such as football shoulder pads and other sporting or safety apparel, and these fall within the scope of disclosed embodiments unless otherwise specified.

In this example, helmet 100 includes an electromagnetic device 110 that can be energized to create an electromagnetic field with repulsion effects as indicated by arrows 140. Electromagnetic device 110 is connected to a control unit 120.

In alternate embodiments, the electromagnetic field could be delivered by virtue of any number of physical implementations of the basic components, such as a multitude of micro or nano elements embedded in the protective layers or in stratas of composite or other layers that contain the basic elements required to produce the electromagnetic field. That is, the helmet's electromagnetic device can be assembled in such a manner as to act as both be the protective layers and provide the desired effect when energized, so that the actual helmet/protective component material is the electromagnetic device.

Control unit 120 includes, for example, a battery 122 and control circuitry 124. Battery 122 powers both the control unit 120 and the electromagnetic device 110. Control circuitry 124 can be implemented as any controller, ASIC, or other control circuitry, and can perform functions as described herein such as controlling power to the electromagnetic device 110, controlling sensors 130, monitoring and controlling the power level of battery 122, performing communication or alerting functions, or otherwise. In various embodiments, control unit can include or communicate with other elements, not shown, such as a wireless communication device, an alerting device, or other components. While this example refers to a “battery,” those of skill in the art will recognize that this term is intended to include any power storage or delivery source that can function as described herein, including power cells, external power sources, or others.

Sensors 130 can be used, in some embodiments, to sense imminent or potential impacts and to signal control unit 120 of such impacts. Sensors 130 can be implemented as radio-frequency (RF) sensors, electromagnetic sensors, sonic sensors, infrared sensors, any combination of these, or any other type of proximity triggering or impact-detection device.

Sensors 130 can also include impact sensors that detect the force of an impact and send an indication to control unit 120. Such implementation can be used to determine when the helmet has sustained an impact significant enough that the wearer may have sustained a concussion or other injury.

Sensors 130 can include other elements, such as microprocessors with corresponding accelerometers and proprietary algorithms that scale proximity and closing rate/velocity when interacting with other reciprocal like units (opposing) or with fixed external points, whether physical or digitally imposed. Disclosed embodiments can therefore function in a multitude of potential scenarios in which the two (or more) microprocessors communicate to control all or part of the electromagnetic compliment physically present within a defined space/s.

A specific example of a magnetic auto-repel shock helmet as disclosed herein is a football helmet worn by the players on a football team. In a given football play, it is not unusual for one player to collide helmet-to-helmet with another player, which can cause risk of concussion, head or neck injury, or other problems.

In use, a helmet 100 as disclosed herein would be worn by both players. If the electromagnetic device 110 on each helmet is continually energized, then as the helmets approach each other, the electromagnetic field created by the electromagnetic device in each helmet will repel the other to reduce or eliminate the impact of collision. Since both helmets are producing such a repulsion electromagnetic field, the cumulative field strength required to dampen (or eliminate) impact is effectively doubled. This allows the size and/or weight of the electromagnetic devices control unit 120 to be reduced.

In cases where the electromagnetic device 110 on each helmet is not continually energized, or is not continually fully energized, sensors 130 sense the proximity of the opposite helmet and signal the control unit 120. Control unit 120 of each helmet, in response, energizes the electromagnetic device 110 to repel the other helmet. In some specific implementations, when no collision is imminent, electromagnetic device 110 is only partially energized to produce a weak electromagnetic field. Sensors 130 are configured to detect such a weak electromagnetic field when another helmet is in close proximity and so signal the control unit 120. Control unit 120 then fully energizes the electromagnetic device to provide a repulsion force before impact occurs.

In some embodiments, the weak magnetic field can include or be replaced by an identifying signal that identifies the specific helmet 100 (or other apparel) for that. Such an identifying signal can function as the weak magnetic field to “trigger” other helmets, but can also be used to specifically identify helmet 100 among other helmets. The identifications of this helmet and other identified helmets can be transmitted to or detected by a control system 150 described below, other detectors or transceivers on or around a playing field, satellite transceivers, or other local or remote systems that can then track the location or status of each helmet. This data can be recorded so as to provide an historical record of player paths during games, velocities, rate of ability to change direction and other data relative to injuries sustained, limits of physical dexterity and performance.

The amount of device effect (repulsion) can vary relative to adjustable presets that depend on collated data provided by the sum of communication between the various processors or other elements described herein. For example, the degree to which electromagnetic device 110 is energized for repulsion purposes can vary based on determinations made by control unit 120 as to the velocity of the incoming collision or other considerations.

In some embodiments, control unit 120 can include an audible or other alarm to notify the wearer of a problem. For example, the audible alarm can be activated to indicate that the battery is near depletion, the helmet has sustained significant impact, or there is an error condition.

In some embodiments, control unit 120 can include a communication device configured to communicate with a control system to indicate battery status, impact forces, or other data. For example, the control unit 120 in a football helmet can communicate with a control system 150 monitored by coaches, trainers, or other personnel to indicate that the battery is near depletion, the helmet has sustained significant impact, or there is an error condition. Any communication device can be used, such as Bluetooth, WiFi, RF, satellite, GPS, or other communication devices and means.

The communication device can be used to transmit the identifying signal discussed above, and can be used for tracking or other purposes, such as for transmitting codes or other data, including the identifiers of specific players or teammates or various player positions that may require more or less repulsion effect. In this way, the degree to which electromagnetic device 110 is energized for repulsion purposes can be customized based on the identifier of the helmet to be repelled and the likely force or injury required to be avoided.

In some embodiments, such a communication device can communicate with other control units 120 or a control system 150 using mesh networking or other techniques. Such embodiments would ensure more robust communications when the wearers are spread out, such as across a football field or on a race track.

Another example implementation would be a construction safety helmet. In such cases, the electromagnetic field generated by the helmet 100 would aid in reducing impacts from responsive materials, such as falling magnetic or ferromagnetic materials.

Another example implementation would be a driving helmet, such as a racing helmet. In such cases, the electromagnetic field generated by the helmet 100 would aid in reducing impacts against the automobile roof or frame. In such cases, and other similar implementations, similar electromagnetic devices, sensors, and control units can be implemented in other objects, such as the steering wheel, frame, or roof of a vehicle, so that if there is a collision, the impact of the helmet against such objects is reduced or eliminated.

In another example implementation, a person may wear a helmet 100 that has an active device as described herein, and that helmet may interact with another helmet or surface that has a similar charged but inert core, such as a permanent magnet, so that an electromagnetic system as described herein only existing in one of the opposing surfaces or elements.

FIG. 2 illustrates a flowchart of a process in accordance with disclosed embodiments that can be performed by a magnetic auto-repel shock helmet or other apparel as disclosed herein.

The helmet produces a weak electromagnetic field (205). The “weak” field is sufficient to be sensed by other helmets, but is not strong enough to significantly repel other helmets. The weak electromagnetic field is produced by the control unit 120 partially energizing the electromagnetic device 110.

The helmet senses the proximity of an opposite helmet (210). The sensors 130 detect an electromagnetic field from the opposite helmet, including in particular a weak electromagnetic field generated by the opposite helmet. The sensors 130 signal the control unit 120 of the detected electromagnetic field.

The helmet repels the opposite helmet using a stronger electromagnetic field (215). In response to the detection, the control unit 120 fully energizes the electromagnetic device 110 to provide a repulsion force between the helmet and the opposite helmet.

Of course, in many cases, both the helmet and the opposite helmet will be using similar devices and processes, so that both helmets detect the other helmet and generate the repulsion force against the other helmet.

Those skilled in the art will recognize that, for simplicity and clarity, the full structure and operation of all helmets or other apparel suitable for use with the present disclosure is not being depicted or described herein. Instead, only so much of a helmet and magnetic repulsion system as is unique to the present disclosure or necessary for an understanding of the present disclosure is depicted and described. The remainder of the construction and operation of anti-shock apparel may conform to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. An impact-reducing item of apparel, comprising:
an electromagnetic device; and
a battery, wherein the battery energizes the electromagnetic device to repel impact forces against the apparel.

2. The apparel of claim 1, wherein the apparel is a helmet.

3. The apparel of claim 1, further comprising control circuitry configured to selectively energize the electromagnetic device.

4. The apparel of claim 3, further comprising at least one sensor that detects an imminent impact.

5. The apparel of claim 4, wherein the control circuitry energizes the electromagnetic device in response to the at least one sensor detecting an imminent impact.

6. An method for reducing impact forces against a helmet, comprising:
producing a weak electromagnetic field by the helmet;
sensing the proximity of an opposite helmet by the helmet; and
repelling the opposite helmet using a stronger electromagnetic field.

7. The method of claim 6, wherein the helmet comprises an electromagnetic device, a battery, at least one sensor, and a control unit connected to the electromagnetic device, the battery, and the at least one sensor.

8. The method of claim 6, wherein the weak electromagnetic field is sufficient to be sensed by the opposite helmet, but is not strong enough to repel the opposite helmet.

9. The method of claim 6, wherein the weak electromagnetic field is produced by a control unit partially energizing an electromagnetic device.

10. The method of claim 6, wherein the proximity of the opposite helmet is sensed by detecting an electromagnetic field produced by the opposite helmet.
